(19) United States
(12) Patent Application Publication
(10) Pub. No.: US 2009/0137742 A1
(43) Pub. Date: May 28, 2009

(54) Ionomers of poly-1-olefin waxes

(75) Inventor: Gerd Hohner, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/313,631

(22) Filed: Nov. 21, 2008

(30) Foreign Application Priority Data
Nov. 23, 2007 (DE) 10 2007 056 440.8

(51) Int. Cl. C08L 33/02

(52) U.S. Cl. 525/221

(57) ABSTRACT

Through hydrolysis of graft products of poly-1-olefin waxes and α,β-unsaturated carboxylic acids it is possible to gain access to innovative ionomer waxes which, in contrast to known ionomer waxes, exhibit low melt viscosities even at high degrees of hydrolysis. The ionomer waxes of the invention are suitable inter alia as components of pigment masterbatches, as plastics additives.

The present invention is described in the German priority application No. 10 2007 056 440.8, filed Nov. 23, 2007, which is hereby incorporated by reference as is fully disclosed herein.

The present invention relates to waxlike ionomers (“ionomer waxes”) of low melt viscosity, based on reaction products of poly-1-olefin waxes with α,β-unsaturated carboxylic acids or their derivatives.

Ionomers based on functionalized polyethylene structures, such as polyethylene structures containing carboxyl groups, are known. They are prepared by reacting, for example, polyethylene containing acid groups, obtained by copolymerizing ethylene and α,β-unsaturated carboxylic acids, in a neutralization or hydrolysis with metal oxides or metal hydroxides.

Polyolefin-based ionomers find use, for example, as additives for plastics, for instance as nucleators for influencing the crystallization behavior and the morphology, as (permanently active or migrating) antistats, and also as processing aids in shaping. They are additionally employed as pigment dispersants in the coloring of plastics with organic or inorganic pigments. From polyolefin ionomers it is possible, furthermore, to produce films for packaging, and coatings.

U.S. Pat. No. 3,264,272 describes ionomers obtainable by partial hydrolysis of high molecular mass, plasticlike copolymers olefins and acrylic acid or methacrylic acid. In the course of the hydrolysis a drastic increase in viscosity is observed, evident from the decrease in the melt index value.

Known from EP 0 054 761 is the reaction of waxlike ethylene-acrylic acid copolymers with metal oxides or metal hydroxides. The viscosities of the raw materials used in the working examples are 500 or 650 mPa·s at 140° C.; in the course of the hydrolysis, the viscosity values increase to a multiple with increasing degree of hydrolysis. For degrees of hydrolysis of more than 50%, viscosity values are no longer reported.

EP 0 104 316 describes the production of ionomers by reaction of low molecular mass copolymers of ethylene and α,β-unsaturated carboxylic acids with oxides of group IIA of the Periodic Table of the Elements.

Low molecular mass waxlike ionomers based on polymers of 1-olefins with more than 2 carbon atoms have not been disclosed to date.

Ionomer waxes can be prepared in principle in a simple way, in a stirred tank process by stirred incorporation of suitable metal compounds into the melt of functionalized waxes. This procedure presupposes that the viscosity remains low enough, during the reaction, to ensure effective mixing of the reaction components and to avoid overloading of the stirring element. This aspect is especially significant when, in order to optimize the performance efficiency of the ionomers, it is necessary to set high degrees of neutralization or of hydrolysis, such as those close to 100%. The existing ionomers based on functionalized polyethylene waxes have extremely high melt viscosities or cannot be melted at relatively high degrees of hydrolysis. Their industrial production therefore necessitates special, laborious modes of operation. This is equally true of their application, where they are applied via the liquid melt state.

It has now been found that ionomer waxes with low melt viscosity can be obtained by hydrolysis of poly-1-olefin waxes which have been functionalized by free-radical grafting with α,β-unsaturated carboxylic acids. More particularly, and unexpectedly, only a moderate increase in the melt viscosity, if any at all, is observed even in the case of complete hydrolysis, up to the maximum metal content.

The invention provides ionomer waxes having a melt viscosity as measured at 170° C. in the range from 5 to 30 000 mPa·s and a dropping or softening point in the range from 70 to 165° C., comprising poly-1-olefins which have been functionalized by free-radical grafting with α,β-unsaturated carboxylic acids or their derivatives and then hydrolyzed.

More particularly, in the case of the ionomer waxes of the invention, at least 30% of the functional groups present in the functionalized wax are hydrolyzed.

The ionomer waxes are prepared from functionalized waxes by reaction thereof with metal compounds, the functionalized waxes having been obtained by free-radical grafting of nonfunctionalized poly-1-olefin waxes with α,β-unsaturated carboxylic acids or their derivatives.

Poly-1-olefin waxes are accessible by grafting of unsaturated acids onto 1-olefin polymers. EP 0 941 257 describes, for example, the reaction of polypropylene waxes with acrylic acid in the presence of di-tert-butyl peroxide as free-radical supplier.

The poly-1-olefin waxes used as a graft base are understood, in contradistinction to plasticlike poly-1-olefins, to be materials having low average degrees of polymerization or chain lengths. These qualities in turn imply low melt viscosities, which in the case of the waxes are typically in the range from about 5 to 30 000 mPa·s, as measured at 170° C., while in the case of the poly-1-olefin plastics they are generally above 1000 Pa·s.

Poly-1-olefin waxes can be prepared by thermal degradation of poly-1-olefin plastics or in a molecular enlargement process by direct polymerization of 1-olefins. Examples of suitable polymerization processes include catalytic processes using organometallic catalysts, Ziegler or metallocene catalysts for example. Corresponding methods of preparing homopolymer and copolymer waxes are described in, for example, Ullmann's Encyclopedia of Industrial Chemistry, 5th ed., Vol. A 28, Weinheim 1996 in section 6.1.2. (Ziegler-Natta polymerization, polymerization with metallocene catalysts), and section 6.1.4. (thermal degradation). The preparation of polyolefin waxes using metallocene catalysts is also described particularly by patent EP 0 571 882, for example.

Suitable poly-1-olefin waxes are not only homopolymers of 1-olefins R—CH═CH2 but also their copolymers with one another or with ethylene, in which R is a straight-chain or branched alkyl radical having 1 to 20 carbon atoms. Copolymer waxes can contain 1-olefins in any desired proportions; in the case of copolymer waxes of 1-olefins and ethylene, the ethylene content may be between 0.1% and 49% by weight.

Preferred starting materials for the grafting are poly-1-olefin waxes obtained by direct polymerization, more preferably those prepared using Ziegler catalysts or metallocene catalysts. Particular preference is given here to polypropylene waxes, in particular propylene homopolymer waxes or copolymer waxes of propylene and ethylene. The poly-1-olefin waxes can contain not only isotactic and syndiotactic structural elements but also atactic structural elements. The copolymer waxes can be of random or block structure.

Graft monomers contemplated include both monobasic and polybasic α,β-unsaturated carboxylic acids. Examples of suitable monobasic acids are acrylic acid, methacrylic acid, ethacrylic acid or crotonic acid. Examples of polybasic acids are maleic acid or fumaric acid. The acids may be used both individually and in plurality as a mixture. Besides the free acids it is also possible to use their derivatives, provided the resulting graft products can subsequently be converted into ionomers. Such derivatives include, for example, esters, examples being esters of acrylic acid such as methyl acrylate, or anhydrides, an example being maleic anhydride. Preferred graft components are acrylic acid and methacrylic acid, with acrylic acid being particularly preferred.

For the graft reaction the α,β-unsaturated carboxylic acids are used in amounts of 0.1% to 60% by weight, based on nonfunctionalized wax employed. The grafting is generally initiated using a free-radical initiator, preferably an organic peroxo compound, such as an alkyl hydroperoxide, a dialkyl or diaryl peroxide or a peroxo ester, for example. The graft reaction may be carried out in solution or in the melt at temperatures adapted to the decomposition characteristics of the peroxide. Preference is given to reaction in the melt.

The poly-1-olefin ionomers are prepared in principle by treating the poly-1-olefin wax obtained by grafting with α,β-unsaturated carboxylic acids or their derivatives, in the liquid melt state or in solution, preferably in the melt, with a metal compound which converts some or all of the acid and/or acid-equivalent functions that are present in the wax into carboxylate functions. The metal compounds used comprise metals preferably of groups IA, IIA, IIIA, IB, IIB, and VIIIB of the Periodic Table of the Elements, more preferably alkali metals and alkaline earth metals, and also zinc. Metal compounds contemplated are generally those which can be converted with acid or acid-equivalent functions into metal carboxylates, examples being hydroxides or oxides. It is also possible to use metal compounds with a salt character, more particularly salts of volatile acids. Preference, however, is given to hydroxides and/or oxides. Examples of metal compounds include sodium or potassium hydroxide, calcium and magnesium oxide or hydroxide, aluminum hydroxide, and also zinc oxide or hydroxide. In one preferred preparation process the melt of the acid wax is introduced as an initial charge and the metal compound, as it is or in solution or dispersion in water, is introduced into the wax melt with stirring. Added water and any water of reaction formed can be removed during the reaction or subsequently by distillation, under atmospheric pressure or subatmospheric pressure, and/or by means of a gas stream, preferably an inert gas stream. The reaction may in principle take place batchwise or continuously.

The proportion of metal compound employed and functionalized poly-1-olefin wax employed is chosen such that a degree of hydrolysis of at least 30% is reached, preferably at least 50%, more preferably at least 70%. Very particular preference is given to degrees of hydrolysis of between 80% and 100%. The degree of hydrolysis indicates the percentage stoichiometric fraction of the acid or acid-equivalent groups originally present that have been converted into carboxylate.

The extent of the formation of carboxylate can be monitored, for example, by determination of the acid number of by means of IR spectroscopy during the reaction, and/or can be ascertained on the end product.

The ionomer waxes of the invention have melt viscosities as measured at 170° C. of less than 30 000, preferably less than 10 000, more preferably less than 5000, with especial preference less than 1000 mPa·s. Their dropping points lie between 70 and 165° C., preferably between 90 and 160° C.

The ionomer waxes can be converted into powders by spraying or grinding and can also be used in that form if advantageous or necessary from a performance standpoint. For grinding, in addition to mechanical mills, jet mills are also suitable, for example. Where brittleness is sufficient, extremely small particle sizes can be achieved, as for example d50 values of <8 μm. The d50 value is a statement to the effect that 50% of the particles have a size below the respective value. The ionomer waxes may also be used in an arbitrarily coarser form, in the form of granules, for example.

The ionomer waxes can be employed, for example, as pigment dispersants in the coloring of thermoplastics with organic or inorganic pigments, as nucleators for influencing the crystallization behavior and the morphology of thermoplastics, and also as (permanently active or migrating) antistatic additives. They are suitable as lubricants and release agents for plastics processing, and can be processed to aqueous or solventborne dispersions for polishing or industrial applications. They can be used, furthermore, as matting additives and abrasion protection additives for coating materials, and for optimizing the mechanical stability and slip properties of printing-ink films.

### EXAMPLES

The invention is illustrated with reference to the following working examples.

The melt viscosities were determined in accordance with DIN 51562 using a rotary viscometer; the dropping points were determined in accordance with DIN 51801/2 and the acid numbers were determined in accordance with DIN 53402. IR spectroscopy measurements were carried out using the Vector 22 instrument (Bruker).

### Examples 1-6

Preparation of Waxes Grafted with α,β-Unsaturated Acids (“Wax Acids”)

2500 g of each of the nonfunctional waxes listed in table 1, column 2, were melted in a nitrogen-blanketed glass apparatus equipped with stirrer mechanism, internal thermometer, and distillation bridge. At a temperature of 150° C., with stirring, the α,β-unsaturated acid listed in column 3 was metered in continuously from a metering funnel over the course of 3 h; at the same time, from a second dropping funnel, the continuous addition took place of 25.0 g of di-tert-butyl peroxide. After the end of metering, the temperature was raised to 160° C. and reaction was allowed to continue for 1 h. Subsequently a vacuum (approximately 30 mbar) was applied and the volatile fractions were removed by distillation. After about 30 min, nitrogen was admitted to let the pressure down to atmospheric pressure. Melt viscosity and acid number of the resulting wax acids are listed in columns 5 and 6.

The following waxes were employed as starting materials:

Licocene® PP 6102, Licocene® PP 4202: polypropylene waxes produced using metallocene catalysts, commercial products of Clariant Produkte (Deutschland) GmbH;

Viscol 550-P: propylene-ethylene copolymer wax, commercial product of Sanyo Chemical Industries.

Reaction of the Wax Acids to Ionomer Waxes

2500 g of each of the functionalized waxes obtained by grafting were melted under nitrogen blanketing in a glass apparatus equipped with stirrer mechanism, internal thermometer, and distillation bridge. At a temperature of 160-170° C., with effective stirring, the alkali metal hydroxide or alkaline earth metal hydroxide specified in column 7 of the following table, in powder form, was introduced over the course of approximately 15 min in portions, in the equivalent ratio specified in column 8. Stirring was continued at 16° C. for 30 min. Subsequently, for drying, vacuum was applied until the melt was free of bubbles. The properties of the resultant ionomer waxes are likewise listed in the following table.

TABLE 1

| 1 | 2 | 3 | 4 | 5 | 6 | 7 | 8 | 9 | 10 | 11 |
|---|---|---|---|---|---|---|---|---|---|---|
| | Preparation/ | | | | | | | | | |
| | properties of wax acid | | | | | | | | | |
| | | | Amount of | | | | | | | |
| | | | acid | | | | | | | |
| | | | component | | | Preparation of | | | | |
| | | | used | | | ionomer wax | | Properties of | | |
| | | | (% by weight, | | | | Base/wax | ionomer wax | | |
| | | | based on raw | Viscosity/ | Acid | | acid | Viscosity/ | Acid | Dropping |
| | | Acid | wax material | 170° C. | number | | equivalent | 170° C. | number | point |
| Ex. | Raw wax material | component | employed) | (mPa · s) | (mg KOH/g) | Base | ratio | (mPa · s) | (mg KOH/g) | (° C.) |
| 1 | Licocene ® PP 6102 | Acrylic acid | 10 | 97 | 68 | KOH | 0.95 | 119 | 5 | 142 |
| 1 | Licocene ® PP 6102 | Acrylic acid | 20 | 110 | 125 | KOH | 0.95 | 196 | 7 | 143 |
| 2 | Licocene ® PP 4202 | Acrylic acid | 10 | 113 | 69 | KOH | 0.95 | 119 | 6 | 121 |
| 3 | Licocene ® PP 6102 | Acrylic acid | 10 | 97 | 68 | NaOH | 1.00 | 127 | 8 | 141 |
| 4 | Licocene ® PP 6102 | Acrylic acid | 10 | 97 | 68 | Ca(OH)2 | 0.95 | 146 | 9 | 143 |
| 5 | Licocene ® PP 6102 | Methacrylic | 10 | 107 | 55 | KOH | 0.95 | 135 | 5 | 142 |
| | | acid | | | | | | | | |
| 6 | Viscol 550-P | Acrylic acid | 10 | 891 | 67 | KOH | 0.95 | 1601 | 5 | 152 |

In accordance with their high degree of hydrolysis, the ionomer waxes prepared have low acid numbers of below 10 mg KOH/g. In the IR spectra there are minor absorption signals or none in the region of the acid carbonyl group (approximately 1700-1710 cm-1), but intense carboxylate bands can be made out in the 1610-1550 or 1420-1300 cm-1 range.

1. An ionomer wax having a melt viscosity as measured at 170° C. of less than 30 000 mPas and a dropping or softening point in the range from 70 to 165° C., comprising one or more poly-1-olefins functionalized by free-radical grafting with α,β-unsaturated carboxylic acids or their derivatives and then hydrolyzed.

2. The ionomer wax as claimed in claim 1, wherein at least 30% of the functional groups present in the one or more poly-1-olefins functionalized by free-radical grafting with α,β-unsaturated carboxylic acids or their derivatives are hydrolyzed.

3. A process for preparing an ionomer wax having a melt viscosity as measured at 170° C. of less than 30 000 mPas comprising the step of reacting one or more functionalized poly-1-olefin waxes with one or more metal compounds, wherein the one or more functionalized waxes are obtained by free-radical grafting of nonfunctionalized poly-1-olefins with α,β-unsaturated carboxylic acids or their derivatives.

4. The process as claimed in claim 3, wherein the nonfunctionalized poly-1-olefins are prepared by polymerizing using Ziegler catalysts or metallocene catalysts.

5. The process as claimed in claim 3, wherein the nonfunctionalized poly-1-olefin waxes are homopolymers of 1-olefins of the formula R—CH═CH₂ or copolymers of the 1-olefins with one another or with ethylene, in which R is a straight-chain or branched alkyl radical having 1 to 20 carbon atoms and the ethylene content is in the range from 0.1%-49% by weight.

6. The process as claimed in claim 3, wherein the one or more metal compounds comprise metals from groups IA, IIA, IIIA, IB, IIB and VIIIB of the Periodic Table of the Elements.

7. The process as claimed in claim 3, wherein the one or more metal compounds are metal oxide, metal hydroxide compounds or mixtures thereof.

8. The process as claimed in claim 3, wherein the proportion of the one or more metal compounds employed and the one or more functionalized poly-1-olefin waxes employed is chosen such that a degree of hydrolysis of at least 30% is reached.

9. An ionomer wax obtained by a process as claimed in claim 3.

10. A pigment dispersant, a nucleator, a lubricant or a release agent in plastics processing comprising an ionomer wax as claimed in claim 1.

11. The pigment dispersant, nucleator, lubricant or release agent in plastics processing as claimed in claim 10, wherein the ionomer wax is used as a powder having d50 values <8 μm.

12. The process as claimed in claim 3, wherein the one or more metal compounds comprise metals selected from the group consisting of alkali metals, alkaline earth metals, zinc and aluminum.

13. A matting additive or abrasion protection additive for coating materials comprising an ionomer wax as claimed in claim 1.

14. An additive in the production of printing-ink films comprising an ionomer wax as claimed in claim 1.
